(19) United States
(12) Patent Application Publication
(10) Pub. No.: US 2006/0051064 A1
(43) Pub. Date: Mar. 9, 2006

(54) Video control system for displaying user-selected scenarios

(76) Inventors: J. Richard Bray, Rogers, AR (US); David V. Clayton, Taylorsville, UT (US)

Correspondence Address: KEISLING PIEPER & SCOTT PLC;Bank of America Plaza, Suite 217, 1 East Center Street, Fayetteville, AR, 72701, US

(21) Appl. No.: 11/216,451

(22) Filed: Aug. 31, 2005

Related U.S. Application Data
(63) Continuation-in-part of application No. 09/666,379, filed on Sep. 20, 2000, now abandoned.
(60) Provisional application No. 60/606,061, filed on Aug. 31, 2004.

(51) Int. Cl. H04N 5/781

(52) U.S. Cl. 386/95; 386/125

(57) ABSTRACT

A method and apparatus for controlling the presentation of video information previously recorded on a digital video disc enables a user to simply select for playback specified segments of the information prerecorded on the video disc with avoidance of objectionable material such as violence, profanity, vulgarity and nudity as identified by a preproduced movie mask file for the particular motion picture or other video information on the video disc. Also disclosed is the structure of such a movie mask file.

### CROSS-REFERENCE TO RELATED APPLICATIONS

This application claims priority to and is a continuation-in-part of U.S. provisional application Ser. No. 60/606,061, filed Aug. 31, 2004. This application also claims priority to and is a continuation-in-part of U.S. patent application Ser. No. 09/666,379, filed Sep. 20, 2000.

### STATEMENT REGARDING FEDERALLY SPONSORED RESEARCH OR DEVELOPMENT

Not Applicable.

### REFERENCE TO A MICROFICHE APPENDIX

Not Applicable.

### RESERVATION OF RIGHTS

A portion of the disclosure of this patent document contains material which is subject to intellectual property rights such as but not limited to copyright, trademark, and/or trade dress protection. The owner has no objection to the facsimile reproduction by anyone of the patent document or the patent disclosure as it appears in the Patent and Trademark Office patent files or records but otherwise reserves all rights whatsoever.

### TECHNICAL FIELD

The present invention relates to the selective playing of video and audio information which is prerecorded in a conventional manner on a DVD or other form of video disc or other digital media including video-on-demand, hard disk internet downloads and the like. In particular, the present invention relates to a method and apparatus for controlling the presentation of information previously recorded in digital form, for example on a digital video disc, that enables an end-user to easily select a user-specified edited version and thus to playback user-specified sequences or segments of the information prerecorded on the video disc by use of a video mask disk preprogrammed on a computer system that identifies sequences or segments of information corresponding to one of several edited versions or scenarios.

### BACKGROUND

A large amount of analog or digital data can be and has been stored on recording medium, such as a video disc or other digital media. In the past, to selectively display that information, even with professional systems, has been a creative and time-consuming task, particularly if a selected sequence of the information was to be displayed in a sequence that is different than a default sequence in which the information was recorded on the recording medium. Generally, an editing process was required, usually involving two recording media. The recording device upon which the information was originally stored had to be precisely controlled to begin and end at the start and stop positions which were to be displayed in the subsequent edited version. This first recording source then had to be carefully synchronized with a second recording source, upon which would be recorded in the medium. Subsequently, if any changes were desired in the sequenced presentation, it was generally necessary to re-edit the recorded sequence to increase or decrease the amount of recorded information to be presented or to add or delete information.

Effort has been directed to simplifying these tasks by the creation of video drivers that enable a computer system to control a video disc player in the same functional manner that manual controls would control the player. (e.g., U.S. Pat. No. 4,449,198). In another system, the user of such a computer system generates a call code or identification byte that is then used by the video disc player to search for the particular frame number on the video disc that the user desires to have played. (e.g., U.S. Pat. No. 4,635,136) Still another system uses multiple video disc players to generate video still pictures based on the sequence of still pictures stored in an external picture program. (e.g., U.S. Pat. Nos. 4,796,099, 4,717,971, and 4, 675,755). Generally, however, such systems have required, at a minimum, an understanding of multiple programming languages to control the computer system and the control functions of the particular video disc system.

A later U.S. Pat. No. 5,109,482 discloses an integrated and interactive control system that allows the user to access to any portion or any sequence of portions of prerecorded information in a manner that enables the editing and playback of the portions in a manner that is individually determined by the end-user, without requiring the end-user to possess a detailed understanding of how to operate the computer system or the video disc player. Subsequent patents proposed use of segment maps to provide alternative playing orders for video disk players (e.g. U.S. Pat. Nos. 5,434,678; 5,724,472; 5,913,013; 6,067,401; and 6,151,444).

The advent of the DVD format particularly adapted for mass distribution of recorded full length feature moving pictures in digital video and audio has created a need for better viewer control of the playback of movies by viewers desiring to avoid violence, profanity, and/or nudity which such scenes have become more often than not present in DVD movies distributed for rent or sale. The same is true of movies or the like stored in other digital medias including hard disk, internet downloads and the like. This need is addressed by the apparatus and method disclosed herein which apparatus effectively automates the consumer's remote control to achieve the “rating reduction” desired (e.g. from R to G or PG.) This is accomplished by using pre-created movie mask files which find where, based on user selections, all the places are that need to be skipped, muted, or otherwise modified. The details of the operation of the apparatus and method incorporating the present invention will better be understood from the following description and illustrations.

### SUMMARY OF THE INVENTION

The present invention does not edit from something to something else. Instead, the apparatus of the present invention quickly, and at the user's control, seeks out and replays the desired video (and audio) automatically from just the video source.

The order in which the video is organized on the video disc is preserved and followed as may be desired. An early CAV video disc was said to store approximately 50,000 frames of video. A CD ROM at about 0.64 Gigabytes may store about 25,000 frames (for a play time of about 0.25 hrs.) The capacity of different DVD formats varies but the common DVD-9 and DVD-10 store about 8 Gigabytes for a play time of about 4.0 hours (over 400,000 frames compared to the CAV video disc numbers.)

The source for information on DVD technology relating to memory capacity and other matters herein is obtained from DVD Demystified, second edition, by Jim Taylor, McGraw Hill 2001. A knowledge of the technology described therein is presumed in the following discussion and explanation, and relevant portions thereof are considered to be expressly incorporated by the above reference. Technical terms herein can be assumed to have the same meanings as set forth in the J. Taylor Glossary (pp. 627-668) unless otherwise indicated herein.

In addition to precise and rapid video replays, the system has the capability to retrieve background or editorial information about the video, which the user can review and manage as desired.

Apparatus of the invention automates the consumer's remote control, using imported, pre-created mask files which know the location of all the places desired to be suppressed, muted, or modified, responding to user settings.

The procedure for consumer use of the apparatus may involve all or some of the following steps:
1. Mask Designers create mask files for a movie.
2. Mask File Resource CD is mailed out periodically or otherwise distributed, for example, automatically downloaded from the internet or preloaded on a hard drive or in a memory device.
3. Customer inserts movie into DVD player.

4. Customer inserts Mask File CD, which copies the mask file into the DVD system.
5. Customer puts movie back into DVD player.
6. Customer watches the movie with objectionable portions suppressed based on user choices for language, violence, and adult themes.

The disclosed (TVG Vision) technology is achieved without copying or altering the source material. Consumers can rent or purchase a DVD from any source, watch it through the TVG Vision supported player and return the DVD unaltered. Incorporated in the system disclosed is a feature allowing the consumer who has no desire to use this movie rating adjustment technology (TVG Vision, e.g.) to decline the service and forego receiving mask files for future movie releases, thereby avoiding the cost and expense associated with this feature. The reasonable expense of the associated hardware and software and the update service is paid over the phone or internet by consumers wishing to maintain activation of the technology and have the choice of selecting a rating for language violence and adult themes with which DVD movies will be played.

It is an object of the present invention to provide an apparatus and method for altering the output of selected portions of digitally encoded audio-visual information such as feature movies on DVD or other digital media pursuant to instructions of the users including selection of a rating modification as to language, vulgarity, violence, nudity, and adult themes.

It is another object of the present invention to provide such apparatus and method incorporating continued optional activation and employment of all the features of the system following a free trial activation.

It is a further objective of the present invention to provide computer software and hardware that operates as a controller for a video disc player that enables the end-user to play back user-qualified custom scenes without requiring the end-user to possess a detailed understanding of internal operation of the computer software or the video disc player.

It is still another objective of the present invention to provide a method and apparatus for controlling the presentation of information previously recorded on a video disc in a player that enables an end-user to easily select and play back only user-acceptable sequences of segments or “scenes” of the information prerecorded on the video disc by manipulating a remote control or other input device and an on-screen menu with choices that represent the character of scenes of video information in terms of potentially unacceptable content.

It is a still further objective of the present invention to provide a method and apparatus for controlling the presentation of information previously recorded on a video disc player that enables a mask maker to create, name and store the control information associated with user-specified “scenes” of the information pre-recorded on a particular video disc such that the control information may be later retrieved to enable the playback of the associated user-specified scenes sequence.

Yet another object of the invention is to provide a method of customizing consumer electronic devices wherein a consumer electronic device is still having many optional features that may be selectively activated and/or deactivated upon payment of a use fee by the purchaser.

These and other objects of the present invention will become apparent by reference to the appended drawings, and the detailed description of preferred embodiments.

### DESCRIPTION OF THE DRAWINGS

FIG. 1 is a schematic diagram of a representative prior art DVD player;

FIG. 2 is a schematic diagram of various hardware and software components of a preferred embodiment of a DVD player including the present invention;

FIG. 3 is a schematic flow chart showing initial operation upon insertion of a DVD disc;

FIG. 4 is a schematic flow chart showing a mask file loading function;

FIG. 5 is a schematic flow chart showing the activation detection and subscriber activation procedure;

FIG. 6 is a schematic block diagram of low level and high level video masking;

FIG. 7 is a schematic flow chart showing user selection of video masker or words filter;

FIG. 8 is a schematic flow chart showing video masking function in DVD movie playback; and,

FIG. 9 is a schematic flow chart showing the business method.

### DETAILED DESCRIPTION

The preferred embodiments of the present invention contemplate that it will usually be incorporated in an otherwise conventional DVD player, DVD-VHS combination, or other widely available consumer device for multimedia presentation. Consequently, it is helpful to discuss the somewhat standard organization of DVD hardware and software for presentation of multimedia, and particularly for showing full length feature motion pictures.

DVD technology is, not surprisingly, much more complex than predecessors such as CD's, magnetic tape, etc. Accordingly, many details regarding DVD technology must here be omitted in the interest of brevity, and the reader is referred to available references such as DVD Demystified by Jim Taylor referred to above, or other references in the extensive literature on this subject.

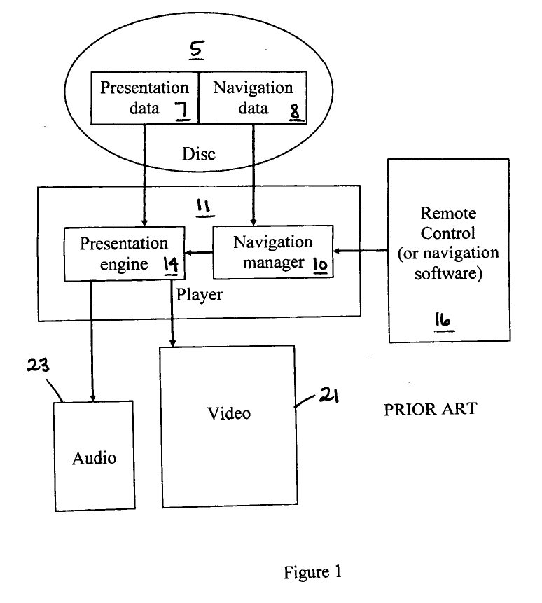

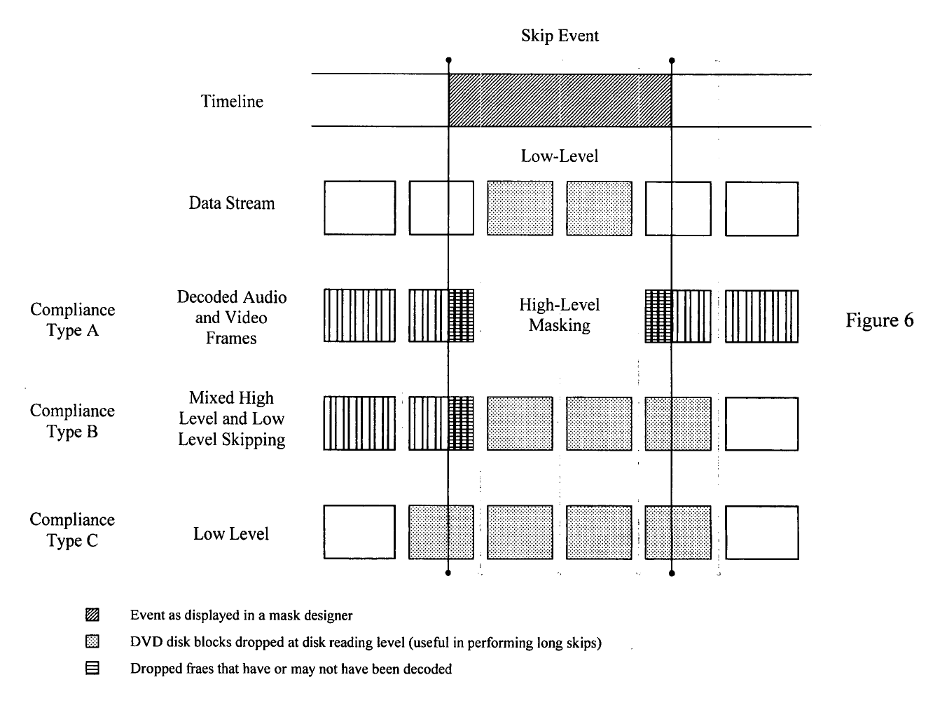

A DVD player incorporates an electro-optical-mechanical system for accessing and extracting raw digital data from a DVD form of laser disc, but equally important is the associated computer and software to control manipulation of the raw data. The overall organization of a simple conventional DVD player is schematically shown in FIG. 1 (from the Jim Taylor reference, FIG. 6.7).

In FIG. 1 the electro-optical and mechanical apparatus of a player 11 for acquiring the raw binary data are not illustrated but may be considered to be an adjunct to a Navigation manager 10. DVD disc 5 has digital data tracks which contain two distinct components, presentation data 7 and navigation data 8.

The Navigation data 8 not only identifies the location of presentation data portions, but also characteristics thereof which may determine how, when, or if it is presented by means of a presentation engine 14.

An essential control element of the system of FIG. 1 is a remote control-navigation software input 16 to the navigation manager 10. One or both of these will typically have flash memory loaded from a CD or other source which serves for high speed implementation of navigation (and presentation) control, Navigation manager 10 also responds to the manual remote control of input 16 (either directly or indirectly).

Although not actually a component thereof, a video 21 and an audio 23 presentation device are required to complete the player system utility. Audio 23 could have from 2 to 5 output channels and video 21 could be NTSC or PAL standard with wide screen or 3×4 display. These and numerous other possible variations in the system are not recounted here, but they are well covered in the Jim Taylor reference.

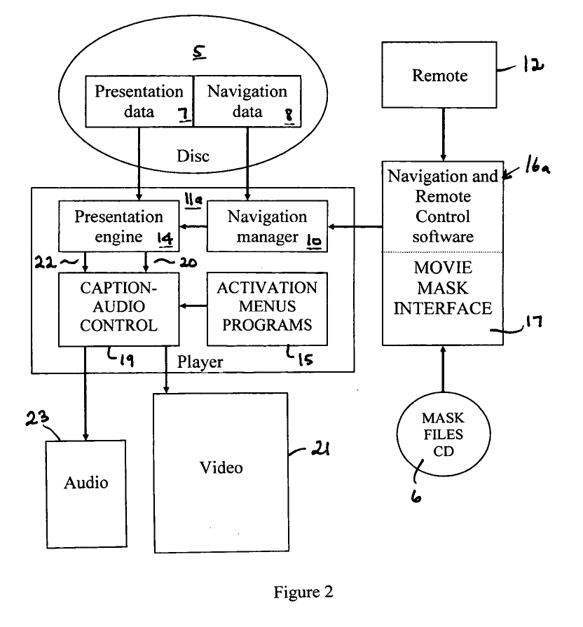

FIG. 2 is a schematic block diagram showing special software and features in a DVD player to implement the system and apparatus disclosed and claimed herein.

As shown in FIG. 2 the essential elements of conventional DVD's (as shown in FIG. 1) are present in the disclosed apparatus according to the invention, in particular disc 5 (with presentation data 7 and navigation data 8), presentation engine 14, navigation manager 10 (incorporated in player 11a), and remote control-navigation software in software unit 16a.

It should first be noted that a caption-audio control 19 in Player 11a is positioned to optionally modify audio and video outputs 22 and 20 from presentation engine 14 as they pass to audio 23 and video 21. The detailed function of caption-audio control 19 is explained in U.S. Pat. No. 6,166,170, Automated Language Filter, and patent application Publication U.S. 2002/0007371 μl. These documents are incorporated by reference here, and in the interest of brevity will not be discussed in detail. Basically caption-audio control implements the words filter function (language filter), relying on NTSC closed captions to identify objectionable text (and audio).

DVD protocol includes support for NTSC Closed Captions. Closed Captions are a standardized method of encoding displayable text into an NTSC television signal. The text can be displayed by a TV with a built-in decoder or by a separate decoder. All TVs larger than 13 inches sold in the United States since 1993 must have Closed Caption decoders.

Even though the terms caption and subtitle have similar definitions, captions commonly refer to onscreen text specifically designed for hearing impaired viewers, whereas subtitles are transcriptions or translations of the dialogue. Captions may be positioned below the person who is speaking. Closed captions are not visible unless the viewer activates them. Open captions are automatically visible, such as subtitles on some foreign videotapes.

Closed Captions on DVDs are carried in the digital (MPEG-2) video stream and are sent automatically to the TV. They normally are turned on or off only from the TV. They are stored as individual character codes (one character per field). Subtitles, on the other hand, are DVD subpictures. Subpictures could also be used to create captions. To differentiate NTSC Closed Captions from subtitles, any captions created as subpictures are usually called “captions for the hearing impaired.” Some old DVD players did not output NTSC Closed Captions. DVD current protocol does not support PAL Teletext, the European equivalent of Closed Captions.

An activation menus, programs unit 15 is included in Player 16a which modifies and supplements the usual software and hardware found in DVD players. Unit 15 may also serve as the menu and control software for the words filter (language filter) function of caption-audio control 19 rather than having that software internal to control 19. It should be noted that the caption-audio control 19 functions independently of the DVD movie mask features of the apparatus of the invention and depends on the presence of recognizable standard closed caption code imbedded in the video NTSC format. Normally such closed caption feature (primarily for the hearing impaired) will be present and in some cases is required by regulation.

In FIG. 2 (like FIG. 1) navigation and remote control software is found in block 16a, but also therein is a movie mask interface 17 serves to properly acquire data from a mask files CD #6. An infrared remote transmitter 12 is separately shown in FIG. 2 (while only implicit in FIG. 1).

Device Specific Routines

To implement DVD File I/O the system loads two files directly from the header of the DVD which enables it to compute the DVD #ID, representing a unique DVD identifier. Mask files in the future may be stored on the DVD themselves; therefore, it is preferred that the mask files be able to be read from DVD media as well as CD. The system normally loads mask files from resource CDs. Such files may also be downloaded from the internet or another memory source such as a hard-drive or the like. The system functions best if the entire block of flash RAM is stored in a temporary buffer for manipulation, and that is a preferred mode. This reduces the possibility of frequent changes and saving.

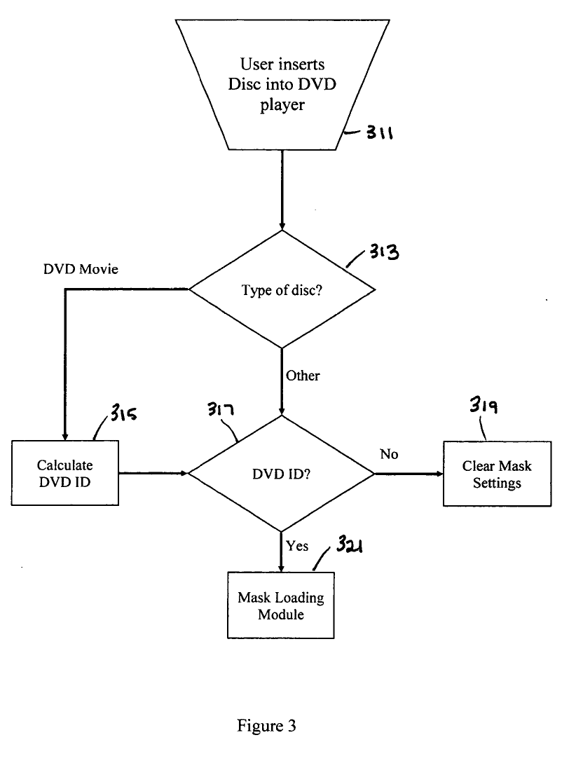

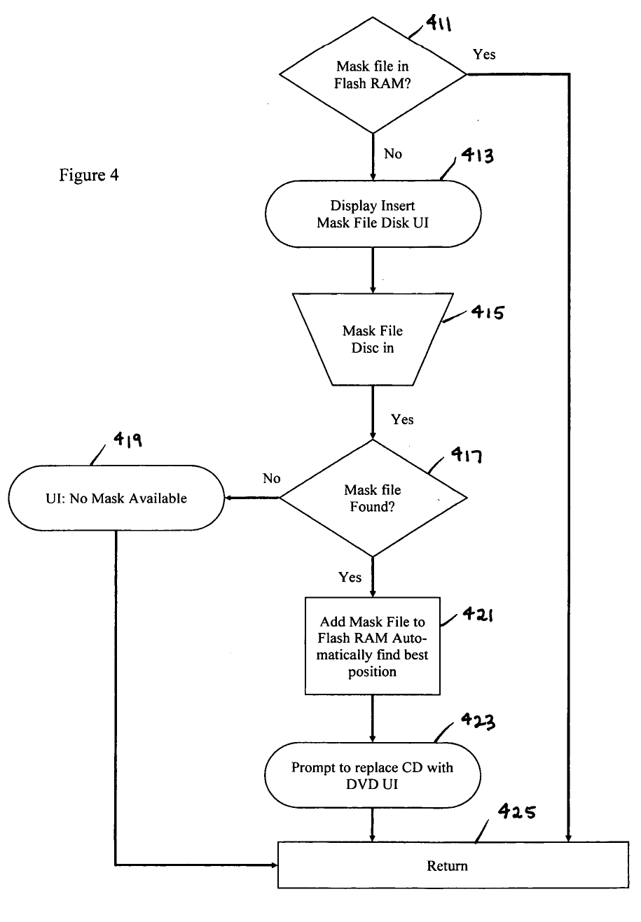

The flow charts of FIG. 3 and FIG. 4 are helpful in explaining use of the system and its use by the end user. When a disk is inserted into the drive, the software does checks for the DVD ID, and searches for a mask file loaded in RAM. This is shown in FIG. 3, blocks 311, 313, 315, 317, 319, and 321, and FIG. 4, blocks 411, 413, and 425. If a mask file is not present in RAM, the user is prompted to insert a mask file disk from which a proper mask file can be loaded to RAM, if available. This procedure is shown in FIG. 4 blocks 415, 417, 421, 423 and 425. This procedure and following procedures are subject to the activation module check routine giving a positive ok (as described later).

This information set forth below is needed to run the system and preferably is stored in the EEPROM or flash RAM.

Global Player Settings

| NAME | SIZE | DESCRIPTION |
|---|---|---|
| UNIT ID | 2 BYTES | Used for activation |
| USER ID | 2 BYTES | Used for activation, user entered |
| master switch | 2 BYTES | Master settings flags, System on/off. |
| | | Masking type. |
| user settings | 4 BYTES | User settings for movies |

The following is a typical list of other items stored in flash RAM.

Flash Storage

| NAME | SIZE | DESCRIPTION |
|---|---|---|
| TVGV_FILE_HEADER | 8 BYTES | File table header for mask file |
| | | storage |
| FILE_TABLE_ENTRY | . . . | File allocation table |
| FILE_ENTRY | . . . | File entries |

Memory and File Management

A memory pointer may point to a temporary buffer for manipulation of the mask file storage area. This reduces the number of times the flash RAM is written to. An address pointer may point to the flash memory block address. Then when the system is ready, temporary mask file pointers point directly to flash RAM, and while the system is running no additional RAM is required.

A file reader is programmed to read the entire flash block into a temporary buffer at the beginning of a session, and if the ram changed during this session, it writes out the entire chunk at the end of the session. This temporary buffer may be taken from main memory that isn't being used, e.g. the decode video buffers, since the movie is paused at all times during access to the user interface. Ideally the flash storage will occupy one bull bank of flash memory of 64K or smaller.

A file manager provides an effective method for storing mask files into flash RAM. Basically, a file has a rank variable that is stored in the file table; this tells the internal system how important this file is. If a user's DVD player has 10 movie mask files stored, and he puts in a new DVD movie disk, the system would re-rank the file entries giving the latest movie the highest priority. If the user entered in a DVD that was already in the system, the file manager would promote this individual file entry (and degrade any other files that have a higher ranking). When a file is requested to be loaded, the system will check the flash storage for this file first before checking the external media such as CD or DVD.

Events are stored with content flags (event flags) which are used within the mask event manager for tripping individual events based on consumer selections of content masking. Examples of types of content flags that may be employed include Language Flags, Violence Flags, Adult Themes Flags, Child Setting, Teen Setting, and Young Adult. Mask Flag settings may be for Language, Violence, and Adult theme types of content at rating levels: Original, Child, Teen, and Young Adult. Original levels may indicate that the mask event check is effectively off. This procedure sets a value that the masking system can access for triggering appropriate ones of the masking components.

Rating level routines are called from the user interface (UI) screens in the video masker Setup screen. The procedure causes the program to set Language Mask Level; Violence Mask Level; and Adult Themes Mask Level. The levels may, for example, be: 0=Off (original), 1=Child, 2=Teen, 3=Young Adult.

The system of the invention as herein disclosed incorporates an activation module which is central to a novel business method allowing the consumer who has no desire to use the video masker form of movie rating adjustment technology to decline the service (and updates for future movie releases). The consumer thereby avoids the costs paid by other consumers wishing to maintain activation and receive mask files updates.

Business Method

Many present consumer electronics devices include chips and memory chips as primary components within their control systems. With the advances recently in chip capacity as well as memory capacity, it has become possible to include more and more features upon a given chipset with an associated memory without exceeding its capacity. Thus, the enhanced capabilities and capacities of conventional chips and circuitry and memory has made possible advances not heretofore available because of their prior limitations.

In accordance with one embodiment of the present invention, it is desirable to provide software associated with a chipset for enabling and disabling specific features in a consumer electronic device at predetermined intervals or occurrences. In particular, it provides such a feature (that may be software driven using such memory chips and chip sets initially available to a consumer upon the purchase of a particular consumer electronic device) that may be initially disabled or become disabled after a predetermined time interval or number of uses of the feature. It is further desirable to provide a method and procedure for reactivating said feature upon payment for the feature by the consumer. This facilitates the inclusion of a large selection of customizable features while reducing the overall cost to the original manufacturer of the consumer electronic device (i.e. Since the manufacturer won't have to necessarily pay royalties for the inclusion of unused technology that cost can be borne by the consumer). The method of the present invention is not limited to DVD players, but may be implemented in a wide array of consumer electronic devices, whose primary similarity is their use of chipsets and memory with additional capabilities to include such software. Examples of consumer electronic devices upon which the invention may be implemented include televisions, videocassette recorders, stereo components including receivers and associated devices, computers, games, refrigerators, microwave ovens, conventional ovens, vehicles such as automobiles, tractors, golf carts, motorcycles, airplanes, helicopters, ships, and the like. Virtually any consumer electronic device having a chip set and a memory along with a input/output means for communicating information to and from the consumer may implement the method of the present invention.

The present invention includes a software routine that either initially disables a desirable feature or that is adapted to permit the operation of a desirable feature for a predetermined period, which predetermined period may be either a time period or a quantity of use period. If the latter, upon the expiration of the predetermined period, the software routine then disables the desirable feature until it is reactivated by the entry of a code. Upon initial use or upon the termination of the desirable feature, the routine displays a message to the consumer alerting them that the feature has been disabled and providing appropriate communication information so that they may obtain the use code necessary to enable the desirable feature.

Once the consumer has followed the instructions regarding the acquisition of a use code, the code can be input into the consumer electronic device to enable the desirable feature. The use permit may be either limited, in the case of a recurring fee, or permanent in the case of a one time only fee. In the case of a recurring fee, the use permit is for a limited duration preferably at the same measure as the initial duration such that the routine does not require modification. The method of the present invention thus facilitates a new method of conducting business for retailers selling consumer electronic devices.

A new method of doing business for manufacturers and retailers of consumer electronic devices is to include software driven features that may be easily enabled, and disabled to facilitate the presentation of a consumer electronic device with multiple desirable features while reducing the overall cost of including such features upon the consumer electronic device. This provides the consumer with an electronic device that has many features that may be disabled so that the consumer may enable only those features the consumer desires to enable. This permits a wide selection of features to be offered upon a consumer electronic device while maintaining a low cost for the consumer electronic device since the customer who purchases the electronic device will eventually pay directly for the desired feature with its associated development cost. It has been previously difficult to implement such practices in a consumer electronic device for lack of a reliable method for presenting the desirable feature in a format that would be present and possibly initially on, turned off after a trial period, and then reactivated again upon the completion of payment and relatively simple reset steps by the consumer. The present invention will permit manufacturers and retailers to pass all of the cost for optional desirable features directly to the consumer and thereby to enable the manufacturer to offer devices with many features at lower cost.

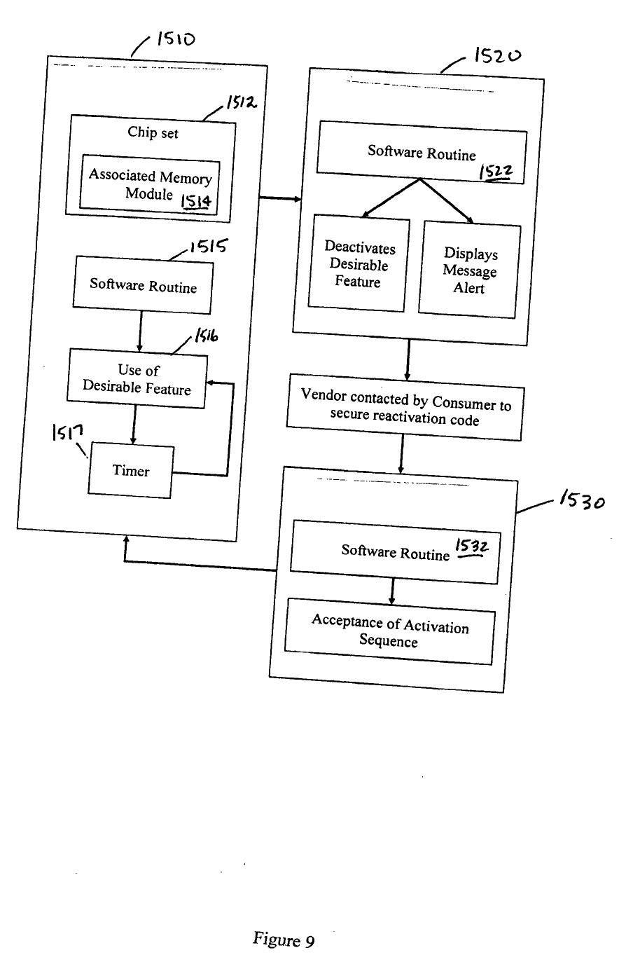

Referring to FIG. 9, a flow chart for the business method is shown in more detail. In FIG. 9, reference numeral 1500 denotes the overall routine in general. FIG. 1510 references the initialization module and FIG. 1520 references the disabling module and reference numeral 1530 references the enabling module.

The consumer electronic device 1502 may, as previously stated, be one of literally hundreds of different devices. By way of example only, the present invention has been successfully implemented in a videocassette recorder and a DVD device. Device 1502 includes conventional chipsets having memory thereon for the inclusion of desirable features that are software driven. Initialization module 1510 includes a chipset 1512 with associated memory module 1514. The activation module further includes a software routine represented by reference numeral 1515. Software routine 1515 may be initially set to permit the initial use of the desirable feature 1516 or the desirable feature may be deactivated initially, in which case control passes to the deactivation module 1520. The desirable feature 1516 may be almost any feature that may be software driven. One desirable feature for which this invention has been implemented includes a foul filter that removes objectionable words and phrases from the audio portion of a program. The module 1510 also includes a timer or a counter 1517, 1518 that is used to measure the usage of the desired feature. Once a predetermined quantity of uses has occurred either as measured by time of usage or by actual numbers of use, the routine passes control to the communication module.

Communication module 1520 receives control of the desirable feature from the activation module. Module 1520 includes software routine 1522 that disables the desirable feature and displays an appropriate communication message that alerts the consumer that the desirable feature has been disabled and that an additional fee is due to continue usage of the desirable feature. The contact information also contains a direction for communication with the vendor for the desired feature. Such communication instructions may include a telephone number, website, written address, etc. It becomes incumbent upon the consumer to then contact the vendor to secure the reactivation information necessary for the reactivation sequence. This message may also be included in user manuals or the like as well.

Once the consumer has contacted the vendor to secure a use code, the consumer may initiate the enablement routine 1530. Enablement routine 1530 includes a software routine 1532 that accepts the use code from the consumer to thereby enable the desirable feature. The user may enter the use code using a numeric keypad or a combination of control buttons or the like to communicate to the electronic device the use code. Once the use code has been successfully entered, the consumer electronic device will resume operation of the desired feature.

As discussed hereinabove, this software driven initialization, disable and enable sequence permits manufacturers to include many software driven consumer features or desirable features upon consumer electronic devices. The manufacturer may instead of paying the owner of such features a fee permit the owner of such feature to collect the fee directly from the consumer. This facilitates the provision of a wide range of such features while not increasing the per unit cost to the manufacturer. This enhances consumer selection as well as consumer satisfaction with the product.

Activation Process

Activation processes are integrated in the words filter plus video masker systems.

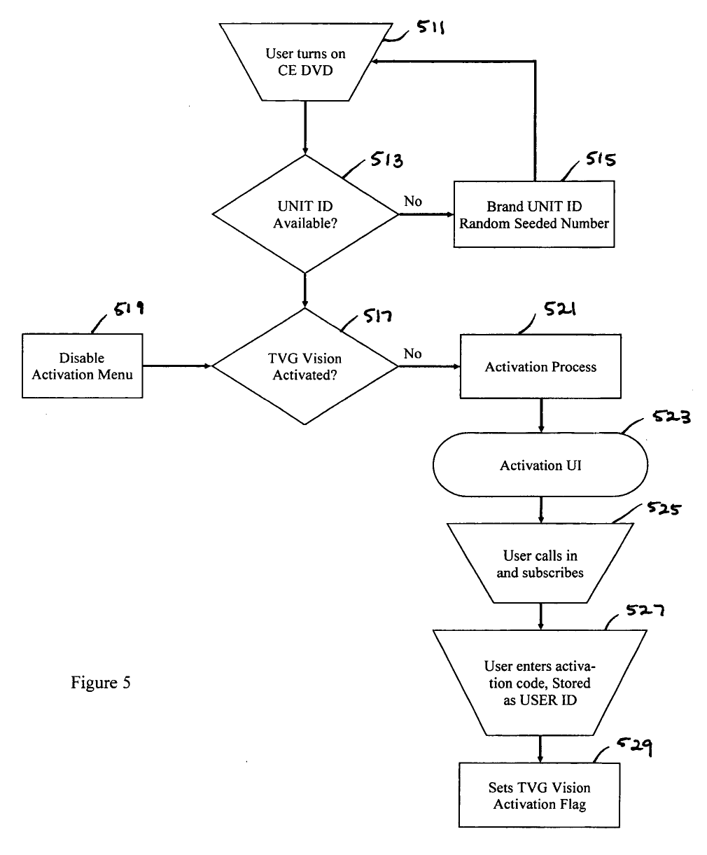

The process basically is shown in FIG. 5 as follows:

1) Create a unit ID (unit identifier) which is a branding based on the random number generator. This unit identifier commands an internal code provided for the user to subscribe to services. This is called by the first call to the activation screens as shown in blocks 511, 513 and 515.

2) Create a user ID, which user identifier is to allow the user to apply for services. It is created by using a simple mangling technique derived from the user ID. This user ID is tracked by internal servers, for additional purposes. After the need for activation is determined, blocks 517, 519, 521; activation may be achieved with the steps of blocks 523, 525, 527, 529; i.e., activation routine UI, user calls in, and subscribes, user enters activation code, activation flag is set to positive.

A mask file header contains basic information for a mask file. Structure of a file header includes: validity checker for mask file, video masker file identifier, mask file format for CE devices, displayable Julian date, copyright string, number of events in mask file, target title, DVD movie title, DVD movie title line 2, DVD movie edition, Designer author name, original DVD ratings, and available mask ratings. Mask files may be stored with the event blocks encrypted to make it more difficult for people to change or manipulate these files illegally. As loaded into flash ram it is stored non-encrypted. Further information regarding the mask file information is given below:
Maskfile_crc_key is an internal validator for the mask file which is computed, and ensures that the mask file has not been modified from its original form.
Version is a Julian date counter used to identify the version information for the particular mask file. This is useful in updating the mask files on the CE DVD device.
Copyright is a legally proper copyright notice.
Count is the number of events in the mask file
Title is primary title that this mask file supports
Movie_title is title of the movie; e.g. “Lord of the Rings”
Movie_title_line_2 is second line of movie title string; e.g. “Return of the King”
Movie_edition is DVD movie edition
Author_name is Mask Designer name
DVD_ratings are flags for the original DVD ratings
AVAIL ratings are available playback rating flags

Other content of a mask file includes: Type of event, trigger event flags, start event info, and end event info.

Masking

Before describing the movie play modes of the system it is useful to discuss the masking function and its operation. Masking is achieved in two different levels. First is the low-level access that is used to facilitate skips that are fairly long in nature, without the need to decode the data stream. Second is a high-level making that drops audio and video frames from the viewing pipeline.

The Mask file format stores the mask files with one of the three types of integration, and the player 11 supports any designated integration level. Type A Integration requires RAM storage to reduce the amount of delay between skips. The required amount of memory is in the range of 12-24 frames. Type B Integration at a decoding level causes a skip start to be detected, and jumps to the nearest VOB boundary for the end of the skip. This requires no additional RAM for buffering. This is a preferred solution over Type C, in that Type B will still have a frame accurate beginning, but the skip end marker is not frame accurate. Type C Integration aligns stored skip information to the VOB pack before the current skip beginning and jumps to the nearest VOB boundary for the end of a skip. This too requires no additional RAM for buffering.

Multi-angle issues are handled on the DVD navigation system within the video masker simply by causing it to only handle playback of the primary angle. Thus, any angle switching during playback results in play back different from that which the consumer may be expecting. For instance if the viewer has requested to view angle two and the system runs into an event; it will likely switch to angle one after an event has been triggered. When an event is being triggered internal to the data returned for an event, it tells how to correctly jump to the correct location of the primary angle. Internal to the Nav_pack data is the position to go to the next Nav_pack for the current angle.

If a stream looks like this: A1 A2 A3 B1 B2 B3 C1C2C3

Normally without doing the TVG Vision processing the software would be doing the following:

| A1 | B1 | C1 |
|---|---|---|
| Play A1 | Play B1 | Play C1 |

Playback
Read A1 data from disk
Read Nav Pack: Next_vobu [VOBU_SRI] points to B1
Send data to video/audio decoders
Read B1 data from disk
Read Nav Pack: Next_vobu [VOBU_SRI] points to C1
Send data to video/audio decoders
Read C1 data from disk
Read Nav Pack: Next_vobu [VOBU_SRI] points to D1
Send data to video/audio decoders

With TVG Vision processing software would do this:

From Event List:

| A1 | B1 | C1 |
|---|---|---|
| Play A1 | Skip B1 | Play C1 |

Playback would be:
Read A1 data from disk
Check Mask Event Manager with A1 Position
Read Nav Pack: Next_vobu [VOBU_SRI] points to B1
Send data to video/audio decoders
Read B1 data from disk
Check Mask Event Manager with B1 Position
Mask Event Manager returns that it needs to skip B1, returns position
of C1
Read C1 data from disk
Check Mask Event Manager with C1 Position
Read Nav Pack: Next_vobu [VOBU_SRI] points to D1
Send data to video/audio decoders

The handling of multi-angle issues may be refined to the extent desired to avoid unexpected results when a user selects an angle to view other than the primary angle. In the disclosed embodiment the simpler procedure of treating only the primary angle is preferred.

The mask file contains a list of events, these events tell what action is to be taken during the playback of the movie. The structure of TV masking event information is, basically:

| | |
|---|---|
| type; | Event type |
| flags; | Flags for event |
| start; | Start of event position |
| end; | End of event position |

The start and end indicators show the position of the disk where the event needs to be triggered, event categories include:

| | |
|---|---|
| Maskevent Skip: | Low and High level skip event |
| Maskevent Mute: | High level mute event |

The FRAMESTAMP is an indicator of where on the disk a particular audio or video frame was found. This is located in the low-level navigational information for the cell (and the head_lba/current_pack/VOB locator.) The program used as a mask file designer saves out the timer information in the frame rate used by the particular movie. The mask file loader then converts this information to the included 90 KHz PTM reference clock.

Playback in Video Masker Mode

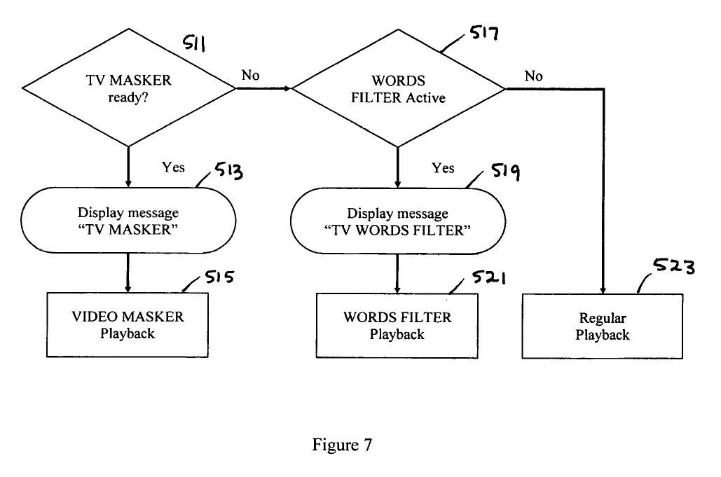

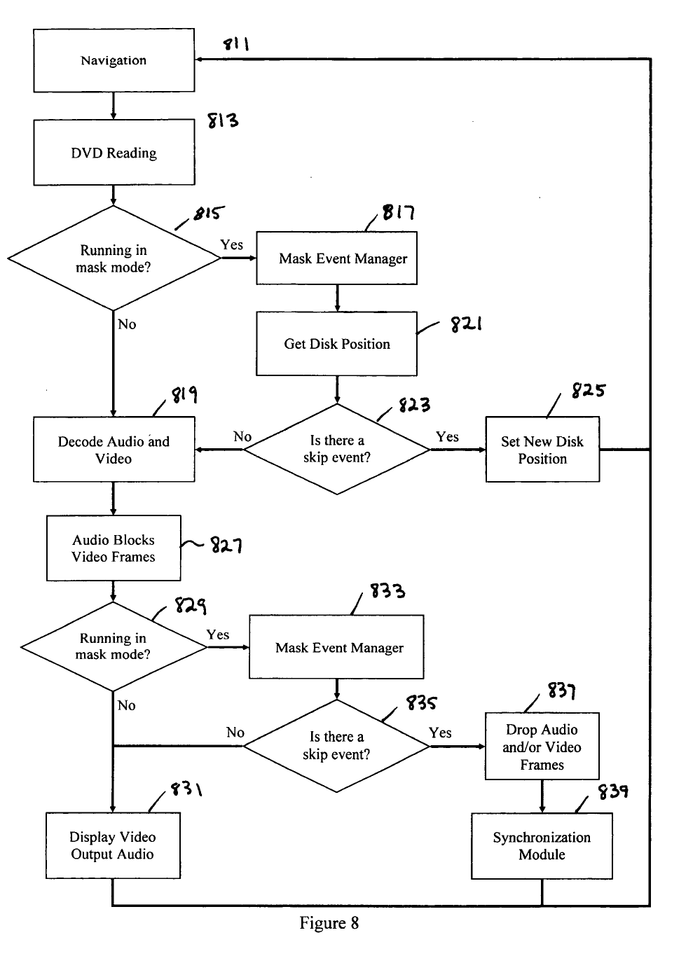

As shown in FIG. 7, based on user menu selections and availability, playback is in video masker mode (via blocks 511, 513, and 515); words filter mode (via blocks 511, 517, 519, and 521); or regular (unmodified) mode (via blocks 511, 517, and 523). FIG. 8 is a flow chart for the operation of video masker mode.

Mask Event Management

A mask event manager parses through the mask events and returns a pointer to events that need to be triggered. As described above these events are triggered in two places, low and high level. Data elements employed are: current title; callback type; short maskflag type; short index; long lb offset; range start; range end.

The data elements serve in the manner described below:

| current title | current title to check | |
|---|---|---|
| callback type | FALSE: | returns only triggered event |
| | TRUE: | callback type |

| | WriteMaskEventToNavBuffer routine is called | |
|---|---|---|
| | which may be specific to the player vendor. This | |
| | allows for direct insertion of events into the DVD | |
| | navigation buffer, for low level skipping. | |
| maskflag type | MASKEVENT_SKIP | Skip event types |
| | MASKEVENT_MUTE | Mute event types |

| | |
|---|---|
| index | Used in optimized event triggering, points to last |
| | triggered event and checks only the |
| | next event in the queue. |
| lb offset | Absolute offset position |
| range start | Start of range to check |
| range end | End of range to check |

The mask manager should be called in checking for mute events in the following manner, and they are triggered most likely in the higher level interface, outside of the navigation and decoding engines of the DVD decoder. Mutes normally operate on a referencing of the same disk position information for all events and a PTM timer reference. This timer is decoded out of the audio packet block and reported to the Mask Manager which returns a pointer to a triggered mute event.

Setting up a maskevent manager info structure involves setting:

| | |
|---|---|
| current title | set to the current title number |
| maskflag type | maskevent mute |
| callback type | FALSE |
| lb offset | Relative offset information |
| index | Used in optimized event triggering, points to last |
| | triggered event and checks only the next event in the |
| | queue |
| range start | Current audio FRAMESTAMP |

When the program returns a pointer to a triggered mute event, then if this returns an event pointer the audio should be muted, but if it does not return an event pointer then the audio should not be muted. These muting functions are separate and distinct from the words filter function (performed by the caption-audio control).

In checking for certain mute events there is a quick method of skipping. For skip events triggered in the low level interface, operation is mainly internal to the DVD navigation and decoding engines of the DVD decoder (in the presentation engine 14 and the navigation manager 10.) Skip Events operate on referencing the disk position information for all events.

Setting up the maskevent_manager_info structure will typically involve:

| | |
|---|---|
| current title | Set to the current title number |
| maskflag type | maskevent skip |
| callback type | FALSE |
| lb offset | Relative offset information |
| index | Used in optimized event triggering, points to last |
| | triggered event and checks only the next event in the |
| | queue |
| range start | Start of range to check |
| range end | End of range to check |

When the program returns a pointer to a triggered skip event, if this returns an event pointer, the next read data block is located within the range end or range start depending on the direction of the playback.

The flow of the masker mode of operation shown in FIG. 8 is helpful in understanding this mode. The DVD navigation routine is essential to this mode (indicated at block 811) as DVD reading (block 813) is directed from navigation. Block 819 directs flow to Mask Event Manager (block 817) unless operation is not in video mask mode, in which case flow diverts directly to Decode Audio and Video (block 819).

Mask Event Manager 817 sends disk position (block 821) to test for a skip event (block 823). If there is no skip event flow proceeds to Decode Audio and Video (block 819). A skip event causes a new disk position (block 825) to be sent for implementation by Navigation 811.

Decode block 819 directs audio blocks and video frames (block 827) to another mask mode checker (block 829) which sends unmodified video to Display Video and Output Audio (box 831), and control is returned to Navigation (block 811) to continue the process. If mask mode is detected at block 829 control goes to Mask Event Manager (block 833) and to an event detector (block 835), which, if there is no event, sends video and audio to Display-Output (block 831), as in the “not mask mode” case.

If event detector 835 detects a skip event, processing flows to high level modification to Drop Audio and/or Video Frames (block 837) and Synchronization Module (block 839) to achieve seamless integration of the modified video by Navigation (block 811). The process shown in FIG. 8 is continued through the video navigation path to show the movie or other video until the end is detected by Navigation (block 811).

There are necessary auxiliary functions such as random number generation, and unique title ID calculation which could be performed in various known manners, but preferably are accomplished as described below.

Random Number Generator

A random number generator is used in creating a unique unit identification system. Essentially the machine is branded with a unique identifier for the users to report when they subscribe. Preferably, there are two portions of the algorithm the random seed pointer and the random number generator. For the returned number to be more random the seed pointer in the main loop is updated.

DVD ID Handler

In calculating a unique disk ID for each title in the TVG Vision specification it is preferred to feed two common files of every DVD (but unique in every DVD) through an algorithm called CRC32 or Cyclic Redundancy Checking. This algorithm is extremely fast and efficient. The files fed through CRC32 are less than 25 K each, so time in calculating a DVD ID will be insignificant. A CRC table preferably is generated on the fly when a DVD is placed into the drive, and then removed immediately. Operation of CRC32 is well known as a way of generating a large (32 bit) specific ID for a digital file of virtually any size. The disk ID code is called when a DVD is placed in the drive and calculates the DVD ID for the DVD currently in the drive.

In addition to the variations and modifications to the preferred embodiments described and suggested above, other modifications will be apparent to those skilled in the art, and accordingly the scope of the invention should not be deemed to be limited by the description of certain embodiments, but should be determined by reference to the claims included herein.

What is claimed is:

1. A system for playing audio/video content, displaying only desired information portions, the information comprising one or more prerecorded segments of video information, each segment comprising one or more frames of video information, the system comprising:
software for identifying user-designated desired information and its location;
software for selecting a user-designated portion of the desired information for display in an interactive, individually controlled manner;
memory for storing a start point and a stop point of each scene of information to be displayed, including memory for storing the start point and stop points for scenes of a user-selectable scenario; and,
software for causing display of only that user-designated portion of information as custom scenes corresponding to the start points and stop points for scenes of a user-selected scenario.

2. In a system as recited in claim 1 further including a menu for user selection of the degree or rating to be applied in altering output to produce a scenario that will suppress objectionable content.

3. The system as recited in claim 1, wherein said recording medium is a motion picture full length feature recorded on an optical disc.

4. The system as recited in claim 2, wherein suppression of output may be selected as audio only, video only or both audio and video.

5. The system as recited in claim 2, wherein conventional navigation data elements employed in commercially available motion picture optical discs are utilized by a navigation module in response to data from a mask file to locate any event portions of a scenario to be suppressed.

6. The system as recited in claim 5, wherein such system is incorporated in a conventional optical disc player and operates at a low level to skip video data before decoding and at a high level to suppress video frames or audio blocks after decoding.

7. A system for altering the output of selected portions of digitally encoded audio-visual material as instructed by a user, the system comprising:
associated software to accept a mask file, read such file, and store a mask file in memory;
a mask file locator and reader;
a navigation module programmed to receive instructions from said mask file locator and reader and to identify mask event portions in said digitally encoded audio-visual material and selectively suppress the output thereof in response to said instructions; and,
a menu for user selection of the degree or rating to be applied in altering output to suppress objectionable content.

8. The system as recited in claim 7, wherein said audio-visual material is a motion picture full length feature recorded on an optical disc.

9. The system as recited in claim 7, wherein said mask file disc is an optical disc of conventional format having multiple motion picture specific mask files recorded thereon.

10. The system as recited in claim 7, wherein suppression of output may be selected as audio only, video only or both audio and video.

11. The system as recited in claim 8, wherein conventional navigation data elements employed in commercially available motion picture optical discs are utilized by said navigation module in response to data from said mask file to locate any event portions to be suppressed.

12. The system as recited in claim 9, wherein such system is incorporated in a conventional optical disc player.

13. A system for altering the output of selected portions of digitally encoded audio-visual material as instructed by a user, the system comprising:
(A) an activation module including:
(1) a stored unique registration key
(2) instructions for a user to communicate the registration key to the system provider and receive a corresponding activation code
(3) an activation enablement program routine to disable the output altering function on certain conditions, and to enable that function upon entry of a valid activation code by usual numerical entry means.
(B) software to accept a mask file, read such file, and store a mask file in memory;
(C) a mask file locator and reader; and,
(D) a navigation module programmed to receive instructions from said mask file locator and reader and to identify mask event portions in said digitally encoded audio-visual material and selectively suppress the output thereof in response to said instructions.

14. The system as recited in claim 13 further including a menu for user selection of the degree or rating to be applied in altering output to suppress objectionable content.

15. The system as recited in claim 13, wherein said audio-visual material is a motion picture full length feature recorded on an optical disc.

16. The system as recited in claim 13, wherein said mask file disc is an optical disc of conventional format having multiple motion picture specific mask files recorded thereon.

17. The system as recited in claim 13, wherein suppression of output may be selected as audio only, video only or both audio and video.

18. The system as recited in claim 13, wherein conventional navigation data elements employed in commercially available motion picture optical discs are utilized by said navigation module in response to data from said mask file to locate any event portions to be suppressed.

19. The system as recited in claim 13, wherein such system is incorporated in a conventional optical disc player.

20. The system as recited in claim 18, wherein such system is incorporated in a conventional optical disc player.
